(19) United States
(12) Patent Application Publication
(10) Pub. No.: US 2006/0100988 A1
(43) Pub. Date: May 11, 2006

(54) Method for generating a search result list on a web search engine

(76) Inventors: Joon Hong, Seoul (KR); Woo Sung, Seoul (KR)

Correspondence Address: LADAS & PARRY LLP, 224 SOUTH MICHIGAN AVENUE, SUITE 1600, CHICAGO, IL, 60604, US

(21) Appl. No.: 10/548,361

(22) PCT Filed: Feb. 27, 2004
(86) PCT No.: PCT/KR04/00413

§ 371 Date: Sep. 7, 2005

(30) Foreign Application Priority Data
Mar. 8, 2003 (KR) 10-2003-0014570

(51) Int. Cl. G06F 17/30

(52) U.S. Cl. 707/3

(57) ABSTRACT

A Computer-readable recording medium in which a program for implementing a method according to any one of claims 1 to 12 is recorded. The present invention relates to a method for selling a search word to a network information provider and providing a search result list to a searcher based on the sales information if the searcher inputs the search word in an Internet search engine. The present invention includes maintaining a database for storing a plurality of search listings therein, each of the search listings including a search word and a network position associated with a network information provider, receiving the search request from the searcher, identifying a search listing having a search word corresponding to the search request, providing the identified search listing to the searcher as a search result list, if the searcher clicks a search listing of the search result list and accesses a network information provider's web page associated with the clicked search listing, receiving predetermined information on the use of the web page by the searcher, and charging the network information provider based on the received predetermined information on the use of the web page by the searcher. According to the present invention, there is provided an Internet search service method and apparatus for providing a variety of billing means to a network information provider by properly reflecting the profit made by the network information provider.

### TECHNICAL FIELD

The present invention relates to a method for selling a search word to a network information provider and providing a search result list to a searcher based on the sales information if the searcher inputs the search word in an Internet search engine. More particularly, the present invention relates to a method for generating a search result list in a search engine, wherein various types of billing are possible and a more proper search word is proposed to the network information provider.

### BACKGROUND ART

U.S. Pat. No. 6,269,361 issued to goto.com (whose company name has since changed to “Overture Service”) discloses a method for displaying a search result in an Internet search engine according to a bid amount proposed by a network information provider. A prior art will be described briefly with reference to FIGS. 1 to 3.

FIG. 1 shows the configuration of a network for providing services that generate a search result list according to a bid amount of a search word in the prior art.

Clients 101 and 102 are devices such as a PC, which are used by a common searcher. Network information provider web servers 106 and 107 are web servers of network information providers, for providing information or a predetermined service through the web server. The network information provider web servers may be operated by a company or an individual. A search engine server 104 provides a web search result in response to a search request of a searcher. At this time, the location of a search listing within the list of the generated web search results is determined depending on the bid amount associated with the search listing. This will be described in detail with reference to FIG. 3. A search database 105 is a database for storing information on a search listing therein, which will be described in detail with reference to FIG. 2.

A typical Internet search engine server outputs a list of web pages corresponding to a search word if a searcher inputs the search word. Such search engine servers include Naver(http://www.naver.com), Google(http://www.google.com), Excite (http://www.excite.com), Lycos (http://www.lycos.com), •Wisenut (http://www.wisenut.com), and the like.

If the searcher accesses the search engine server and inputs a search word, for example “digital camera” to request a search, the search engine server displays a list of web sites including titles and short description, which are related to the term “digital camera”. The searcher then clicks a search listing regarding an interesting web site among the web sites displayed in the list and thus moves to the web site.

According to the prior art by Overture, the search engine service provider sells a search word to a network information provider. For example, a digital camera seller or a digital camera manufacturer can buy the search word “digital camera”. Thus, digital camera sellers or the digital camera manufacturers can have their search listing located at the top in a search list result screen, which is displayed when a searcher inputs the search word “digital camera” in the search engine server 104.

FIG. 2 shows the configuration of a search database in the prior art.

A search database 201 stores a plurality of search lists therein. Each of the search lists contains a title 202, URL 203, description on a web page 204, a search word 205 and a bid amount 206. The title 202 is a name assigned to a corresponding web page. The URL 203 is a network address of a corresponding web page. The description on the web page 204 refers to simple description on a web page. The search word 205 is information on whether to display a search listing if a searcher inputs a predetermined search word. If a search word for which a user requests a search and a search word contained in a search listing are identical, a search engine server displays a corresponding search listing as a search result. At least one search word is included in the search listing.

The bid amount 206 is an amount that a network information provider pays a search service provider per click if a searcher clicks a corresponding search listing. The network information provider accesses the search engine server 104 to input the bid amount 206 for own search listing. If a search listing corresponding to the same search word contains more than one search result, the search engine server 104 arranges the search listing according to the bid amount if the search word is input. In other words, a search listing having a higher bid amount is positioned at a higher place in a search result list. Furthermore, if the searcher clicks the search listing, a network information provider is accordingly charged the bid amount.

FIG. 3 is a flowchart illustrating sequences of embodying a method for generating a search result list and claiming payment according to a bid amount of a search word in the prior art.

In step 301, an Internet search service provider maintains search databases 105 and 201 for storing the title 202, the URL 203, the description on the web page 204, the search word 205 and the bid amount 206 therein. In step 302, the search engine server 104 receives a search request from a searcher. The reception of a search request from a searcher is usually performed in a web page of the search engine server 104 through a search word input field. If the searcher inputs a search word to the search word input field and sends the search word to the search engine server 104, the search engine server 104 receives the search word. In step 303, the search engine server 104 searches the search database 105 for a search listing containing the same search word as the input search word. In step 304, the identified search listing is arranged in order of the bid amount and is displayed as a search result list. In step 305, the searcher clicks one of the search listings within the search result list. The search engine server 104 then provides the searcher with connection to a web server of a network information provider corresponding to the URL included in the search listing. In step 306, charge is performed for the network information provider equal to the bid amount.

In case of billing per click according to the prior art, however, there is a problem in that the profit made by a network information provider through a click is not properly reflected. The network information provider will try to pay the fee when he or she receives assistance helpful to his or her business rather than to pay a fee per click, in generating a search result list through a search engine. Accordingly, there is a need for an Internet search service for receiving a request of such a network information provider and providing a variety of billing means.

Furthermore, in the prior art, even when a search listing of a network information provider is displayed following a second page for a search request of a searcher, it is charged only if there is a click. A search result list displayed following the second page is very low in an advertising effect for searchers. Thus, to claim payment even for a search listing displayed following the second page makes network information providers feel dissatisfied. For this reason, there is a need for an Internet search service for not claiming payment for a search listing displayed following the second page.

In the prior art, the selection of a search word to be advertised is entirely up to only a network information provider. No information for selecting a search word suitable to the network information provider is provided. Therefore, a searcher, who wants to have his or her search listing located at the top using a conventional Internet search service, can unnecessary waste money by selecting an improper search word. Thus, there is a need for an Internet search service for providing a network information provider with additional information for the selection of a search word. In addition, if a network information provider purchases all the related search words (writing a bid amount) in order to increase advertising effects, it will be very useful to provide related search words to the network information provider. However, the prior art does not support such a function.

Furthermore, in the prior art, with respect to a plurality of network information providers who propose the same bid amount, a search listing associated with a network information provider, which is first registered, is displayed at an upper portion and a search listing associated with a network information provider, which is registered later, is displayed at a lower portion. In this case, however, there is a problem in equity since a search listing associated with a network information provider that is registered later is always displayed at a lower portion even though the provider proposes the same bid amount.

### DISCLOSURE OF INVENTION

The present invention is conceived to solve the aforementioned problems in the prior art. An object of the present invention is to provide an Internet search service method and apparatus for providing a variety of billing means to a network information provider by properly reflecting the profit made by the network information provider.

Another object of the present invention is to provide an Internet search service method and apparatus for not claiming payment for a search listing displayed following the second page.

A further object of the present invention is to provide an Internet search service method and apparatus wherein a network information provider who wants to purchase a search word is provided with a search word analogous to the search word, so that the network information provider selects a more proper search word or a plurality of search words to increase advertising effects.

A further object of the present invention is to provide a method and apparatus for equally displaying a search result list to a plurality of network information providers who propose the same bid amount for the same search word.

A further object of the present invention is for allow an image included in a search listing to be very attractive to a searcher and a network information provider to easily input and modify information of a search listing.

To achieve the objects and overcome the problems in the prior art, the present invention provides maintaining a database for storing a plurality of search listings therein, each of the search listings including a search word and a network position associated with a network information provider, receiving the search request from the searcher, identifying a search listing having a search word corresponding to the search request, providing the identified search listing to the searcher as a search result list, if the searcher clicks a search listing of the search result list and accesses a network information provider's web page associated with the clicked search listing, receiving predetermined information on the use of the web page by the searcher, and charging the network information provider based on the received predetermined information on the use of the web page by the searcher.

According to aspect of the present invention, there is provided a method for generating a search result list using a computer network in response to a search request from a searcher, comprising the steps of maintaining a database for storing a plurality of search listings therein, each of the search listings including a search word and a network position associated with a network information provider, receiving the search request from the searcher, identifying a search listing having a search word corresponding to the search request, arranging the identified search listing as a search result list, and if the searcher clicks a search listing of a search result list displayed at a first page of the search result list arranged as the search result list, performing a predetermined charge to the network information provider, and if the searcher clicks a search listing of a search result list displayed at other pages except for the first page, not performing the charge to the network information provider.

According to aspect of the present invention, there is provided a method for generating a search result list using a computer network in response to a search request from a searcher, comprising the steps of maintaining a database for storing a plurality of search listings therein, each of search listings including a search word and a network position associated with a network information provider, maintaining the output number of a search listing provided at a first page as a search result list, in response to the search request of a searcher, receiving the search request from the searcher, identifying a search listing having a search word corresponding to the search request, determining the number of billing search listings charged to the network information provider associated with the identified search listing, and if the number of the billing search listings is greater than the output number, arranging all of the billing search listings at a first page of a search result display page and providing the same.

According to another aspect of the present invention, there is provided a method for generating a search result list using a computer network in response to a search request from a searcher, comprising the steps of: maintaining a database for storing one or more analogous search words associated with a search word therein, receiving a search word associated with a predetermined search result listing display method at an Internet search engine from a network information provider, identifying an analogous search word associated with the search word from the database, providing the network information provider with the identified analogous search word, receiving an input regarding a purchase of the search word or the analogous search word from the network information provider, receiving a search request from the searcher, identifying a search listing having a search word corresponding to the search request, and providing the identified search listing to the searcher according to the predetermined search result listing display method.

According to another aspect of the present invention, there is provided a method for generating a search result list using a computer network in response to a search request from a searcher, comprising the steps of maintaining a database for storing a plurality of search listings therein, each of the search listing including a search word and a network position associated with a network information provider, receiving a bid amount for a search listing associated with a first network information provider from the first network information provider, receiving the search request from the searcher, identifying a search listing having a search word corresponding to the search request, arranging the identified search listing as a search list according to each bid amount associated with the identified search listing, receiving a bid amount for a search listing associated with a second network information provider from the second network information provider, and providing the first network information provider with information on that the order within the search list of the search listing associated with the first network information provider is changed due to the bid amount inputted by the second network information provider.

According to another aspect of the present invention, there is provided a method for generating a search result list using a computer network in response to a search request from a searcher, comprising the steps of maintaining a database for storing a plurality of search listings therein, each of the search listings including a search word and a network position associated with a network information provider, receiving a first bid amount for a search listing associated with a first network information provider from the first network information provider, receiving a second bid amount for a search listing associated with a second network information provider from the second network information provider, receiving the search request from the searcher, identifying a search listing having a search word corresponding to the search request, and arranging the identified search listing as a search list according to each bid amount associated with the identified search listing, wherein if the first bid amount and the second bid amount are identical, the search listing associated with the first network information provider and the search listing associated with the second network information provider are rolled and arranged.

According to another aspect of the present invention, there is provided a method for generating a search result list in response to a search request input through a communication network from a searcher, comprising the steps of receiving a web page title, a web page description, an image file, a search word, and a bid amount associated with a network information provider's web page from the network information provider, generating a search listing substantially in real time in combination with the web page title, the web page description, and the image file and providing the generated search listing to the network information provider, receiving a confirmation input of the network information provider for the generated search listing, associating the search word with the search listing, receiving the search request from the searcher, identifying a search listing associated with a search word corresponding to the search request, generating a search result list by arranging the identified search listing in order of a bid amount associated with the identified search listing, and providing the generated search result list to the searcher.

### BRIEF DESCRIPTION OF DRAWINGS

FIG. 1 shows the configuration of a network for providing services that generate a search result list according to a bid amount of a search word in the prior art.

FIG. 2 shows the configuration of a search database in the prior art.

FIG. 3 is a flowchart illustrating sequences of embodying a method for generating a search result list and claiming payment according to a bid amount of a search word in the prior art.

FIG. 4 shows the configuration of a network for providing a billing service to a network information provider according to an embodiment of the present invention.

FIG. 5 is a flowchart illustrating sequences of embodying a method for charging a network information provider according to an embodiment of the present invention.

FIG. 6 is a block diagram illustrating the construction of a search engine server, a search database and a billing server, for charging a network information provider according to an embodiment of the present invention.

FIG. 7a is a flowchart illustrating sequences of embodying a method of generating a search result list and demanding payment based on a bid amount of a search word according to an embodiment of the present invention.

FIG. 7b is a flowchart illustrating sequences of embodying a method wherein a search listing associated with a search word sold to a network information provider is always displayed on the first page of a search result for the search word according to an embodiment of the present invention.

FIG. 8 shows the configuration of a network for providing services that sell a search word to a network information provider according to an embodiment of the present invention.

FIG. 9a shows the configuration of an analogous search word database, for selling search words to network information providers according to an embodiment of the present invention.

FIG. 9b shows the configuration of an analogous search word database according to another embodiment of the present invention.

FIG. 10 is a flowchart illustrating sequences of embodying a method for selling a search word to a network information provider according to an embodiment of the present invention.

FIG. 11 is a block diagram illustrating a search word selling server and an analogous search word database for selling a search word to a network information provider according to an embodiment of the present invention.

FIG. 12 is a flowchart illustrating sequences of embodying a method for notifying a network information provider of the fact that the rank of a search listing displayed within a search result list is changed according to an embodiment of the present invention.

FIG. 13 is a flowchart illustrating sequences of embodying a method for generating a search result list according to an embodiment of the present invention.

FIG. 14 shows a search result list generated according to the embodiment of FIG. 13.

FIGS. 15a, 15b, and 15c are flowcharts illustrating sequences of receiving a search listing including an image file and a bid amount from a network information provider, and displaying a search listing associated with a network information provider who is successfully bidden at a predetermined region when displaying the search listing according to an embodiment of the present invention.

FIG. 16 shows a search result screen displayed according to the embodiments illustrated in FIGS. 15a, 15b and 15c.

FIG. 17 shows a screen for receiving information on a search listing from a network information provider.

FIG. 18 shows a screen for displaying a search listing that will be provided to a searcher to a network information provider substantially in real time on the basis of search listing information input by the network information provider.

FIG. 19 shows a search result list generating system for generating and storing a search listing substantially in real time based on information provided by a network information provider according to an embodiment of the present invention.

FIG. 20 is an internal block diagram illustrating the configuration of a general-purpose computer system, which can be adopted to construct a search engine server, a billing server, a network information provider web server and a search word selling server according to the present invention.

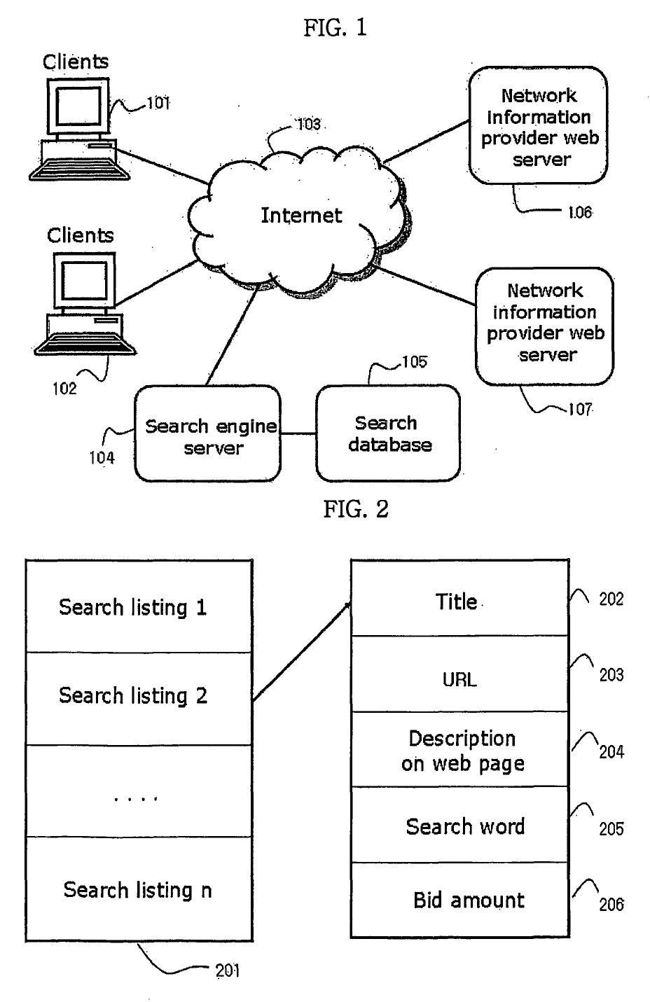

### BEST MODE FOR CARRYING OUT THE INVENTION

Hereinafter, preferred embodiments of the present invention will be described in detail with reference to the accompanying drawings.

FIG. 4 shows the configuration of a network for providing a billing service to a network information provider according to an embodiment of the present invention.

The present invention is the same as the prior art in that a client 401 is connected to a search engine server 404 through an Internet 402 and a searcher inputs a predetermined search word to request a search to the search engine server 404. If the searcher clicks a search listing corresponding to a network information provider web server 406 among a search result list provided by the search engine server 404, the client 401 is connected to the network information provider web server 406.

According to an embodiment of the present invention, if the searcher clicks the search listing of the search result list, the client 401 is not directly connected to the network information provider web server 406, but is connected to an agent server 407. Therefore, the agent server can confirm that a current access request is received from the search engine server 404. According to another embodiment of the present invention, the search engine server 404 transfers URL containing a field that can identify a search engine server to the network information provider web server 406 when requesting an access to the network information provider web server 406. Accordingly, the network information provider web server 406 can confirm that the current access request is received from the search engine server 404.

The network information provider web server 406 transfers predetermined information on how a user uses a web page of the web server 406 to the search engine server 404 after the access request. The search engine server 404 then charges the network information provider. Information on how the user used a web page of the web server 406 may be information on whether a searcher becomes a member to a service provided by the network information provider. If a searcher becomes a member of the web server 406, information on the searcher is stored in a member information database 408. If the searcher who is connected to the network information provider web server 406 through the search engine server 404 becomes a member of the web server 406, it can be said that the network information provider makes some profit from the Internet search service provider to that extent. The network information provider pays the Internet search service provider its bid amount. The payment may be performed substantially in real time simultaneously when the searcher become a member or may be charged at a predetermined period.

According to another embodiment of the present invention, the predetermined information may be information on whether the searcher has used a charged service provided by the network information provider web server 406. The web server 406 stores therein information on whether the searcher who is connected to the network information provider web server 406 through the search engine server 404 has used the charged service provided by the web server 406 and then transfers the information to the search engine server 404. The search engine server 404 then demands payment to the network information provider accordingly.

According to another embodiment of the present invention, the predetermined information may be service use fee information on how much the searcher used the charged service provided by the network information provider web server 406. The web server 406 stores therein service use fee information on how much a searcher, who is connected to the network information provider web server 406 through the search engine server 404, used the charged service provided by the network information provider web server 406. The web server 406 then transfers the information to the search engine server 404. Then, the search engine server 404 claims demand to the network information provider accordingly.

According to another embodiment of the present invention, the web server 406 is a web server that performs electronic commerce. The predetermined information is product purchase fee information on the amount of money the searcher spent purchasing goods using electronic commerce provided by the web server 406. The web server 406 stores therein product purchase information on how much the searcher, who accessed the network information provider web server 406 through the search engine server 404, has purchased using electronic commerce provided by the web server 406. The web server 406 then transfers the information to the search engine server 404. Next, the search engine server 404 claims demand to the network information provider accordingly. In this case, the search service provider can demand payment to the network information provider equal to the bid amount or can claim payment in proportion to the product sales amount. In case where payment is demanded in proportion to the product sales amount, the search database 405 maintains predetermined ratio information in a search listing instead of storing fixed price information such as bid amounts.

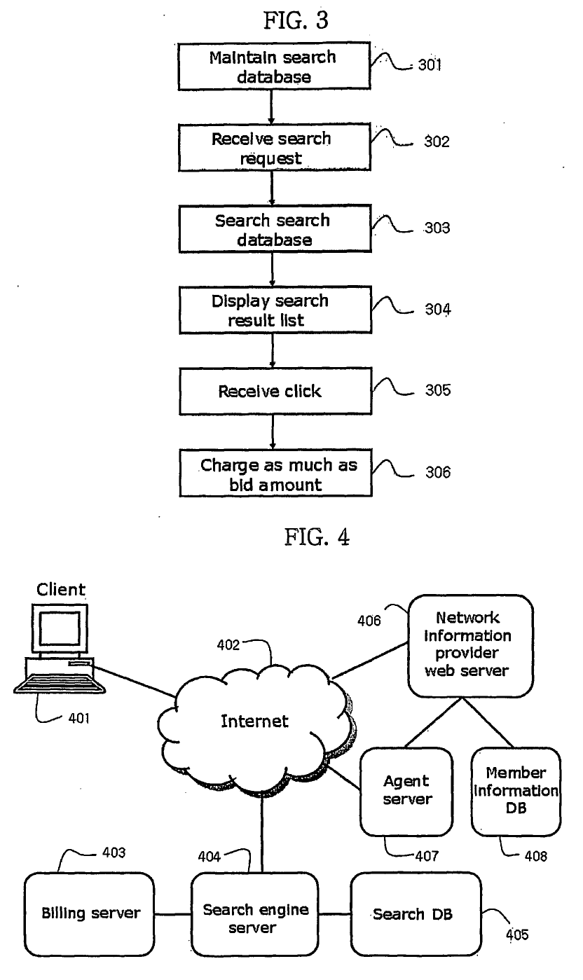

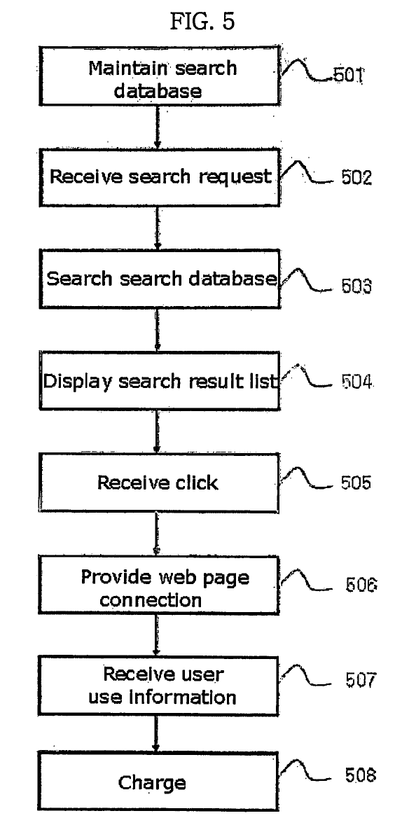

FIG. 5 is a flowchart illustrating sequences of embodying a method for charging a network information provider according to an embodiment of the present invention. Steps 501 to 504 in FIG. 5 are the same as steps 301 to 304 in FIG. 3. Therefore, description will be given beginning step 505.

In step 505, the searcher clicks a search listing of a search result list displayed as a search result and the search engine server 404 receives the click. In step 506, the search engine server 404 provides the client 401 with an access to the web server 406. In step 507, information used by the searcher who is connected to the web server 406 is provided to the search engine server 404 by means of the web server 406. Use information of the searcher is information on whether the searcher has became a member of the web server 406 or whether the searcher has used a charged service of the web server. In step 508, the search engine server 404 charges a network information provider based on web server use information of the searcher. According to an embodiment of the present invention, every time a searcher becomes a member of the web server 406, the network information provider is charged the bid amount of a search listing.

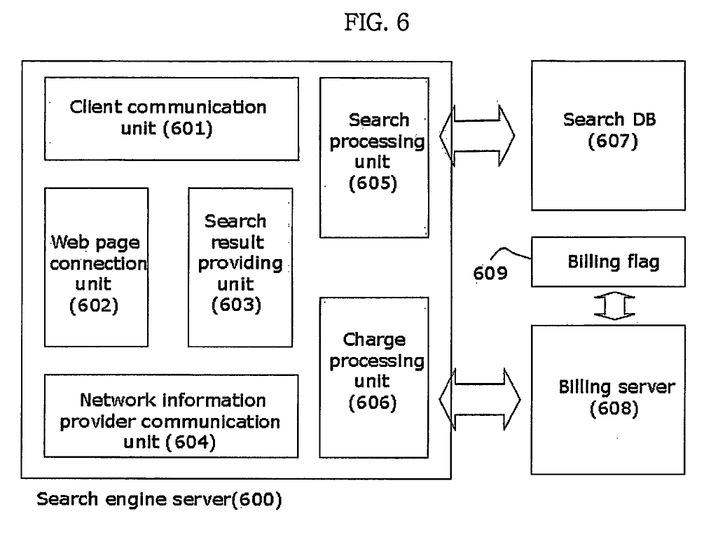

FIG. 6 is a block diagram illustrating the construction of a search engine server, a search database and a billing server, for charging a network information provider according to an embodiment of the present invention.

According to an embodiment of the present invention, a search engine server 600 includes a client communication unit 601, a web page connection unit 602, a search result providing unit 603, a network information provider communication unit 604, a search processing unit 605, and a charge processing unit 606.

The client communication unit 601 performs a function necessary for the search engine server 404 to make communications with the client 401. The client communication unit 601 serves to receive a search request from the client 401, and receive a search result from the search result providing unit 603 and then provide the search result to the client 401. Furthermore, the client communication unit 601 receives a click input from the client 401 and provides the click input to the web page connection unit 602, so that the client 601 is connected to the web server 406.

The web page connection unit 402 allows the client 401 to be connected to the web server 406 corresponding to a search listing if a searcher clicks the search listing of the search result list. The search result providing unit 603 sends a search word input by the searcher to the search processing unit 605 and then receives a search result list. The unit 603 also provides the search result list to the client communication unit 601 and then transfers it to the client 401. The search database 607 stores a search listing containing a search word, URL information, etc. therein. The search processing unit 605 searches the search database for a search listing containing the same search word as the search word input by the searcher and then generates a search result list.

The network information provider communication unit 604 receives information on whether the searcher has used the web server 406 from the web server 406. The network information provider communication unit 604 transfers the received information to the charge processing unit 606 so that a charge is performed based on the use information. According to an embodiment of the present invention, if the searcher has become a member of the web server 406, the web server 406 transmits information that the searcher has become a member to the network information provider communication unit 604 of the search engine server 600. The network information provider communication unit 604 transfers such information to the charge processing unit 606.

The charge processing unit 606 charges the network information provider the bid amount through communications with the billing server 608.

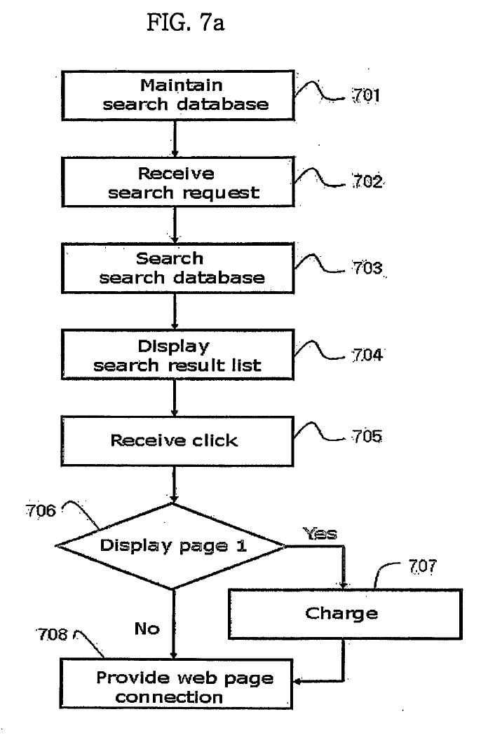

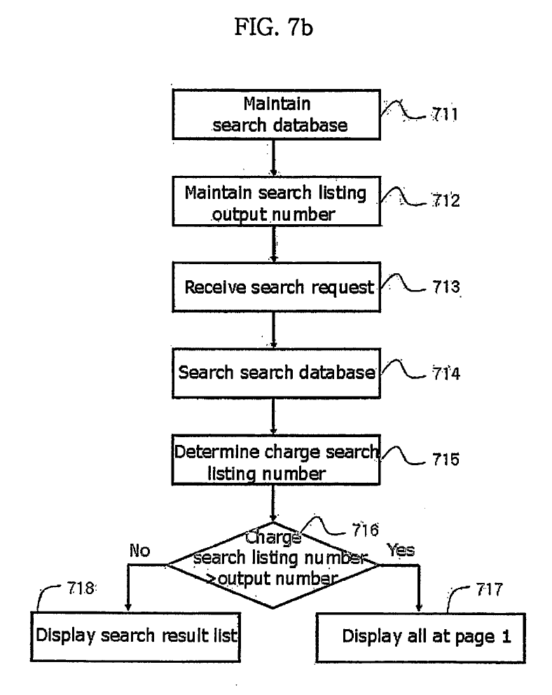

FIG. 7a is a flowchart illustrating sequences of embodying a method of generating a search result list and demanding payment based on a bid amount of a search word according to an embodiment of the present invention. Steps 701 to 705 in FIG. 7 are the same as steps 301 to 305 in FIG. 3. Only description will be given beginning step 706.

In step 706, the search engine server 404 determines whether a search result list arranged according to a search request of a searcher is displayed at the first page. If the search result list is not displayed at the first page, payment is not claimed since advertising effects are low. Therefore, direct connection to a web page is provided (step 708). Furthermore, the billing flag 609 of FIG. 6 is set to “0” so that payment is not demanded. Since payment has to be demanded if a displayed search result list is displayed at the first page, the billing flag 609 is set to “1”. In this case, in step 707, payment as much as a bid amount is claimed to the network information provider corresponding to the search listing.

FIG. 7b is a flowchart illustrating sequences of embodying a method wherein a search listing associated with a search word sold to a network information provider is always displayed on the first page of a search result for the search word according to an embodiment of the present invention.

In step 711, a search database is maintained. The search database stores therein URL associated with a network information provider, a search word, and a purchase field indicating whether the network information provider has purchased the search word.

According to an embodiment of the present invention, the purchase field is a bid amount that a network information provider pays per click when the provider's search listing of a search result list is clicked. In step 712, in response to the search request of the searcher, an output number of a search listing that is provided at page 1 as a search result list is stored. It is common that the number of search listings that are output per page is limited to a predetermined unit as a search result. Therefore, as a result of a search, the output number of search listings displayed on the first page is stored. A search word is received from the searcher (step 713). A search listing having a search word equal to the input search word is identified (step 714).

In step 715, the number of billing search listings that are charged to a network information provider associated with the identified search listing is determined. This can be known by referring to a purchase field within the identified search listing. According to an embodiment of the present invention, the purchase field is a bid amount that a network information provider pays per click if the provider's search listing of a search result list is clicked. In this case, if the bid amount is 0, it means that the network information provider did not purchase it. If the bid amount is greater than 0, it indicates that the network information provider purchases it. Accordingly, in this embodiment, the number of search listings of the searched search list whose bid amount is greater than 0 becomes the number of a billing search listing.

In step 716, it is determined whether the number of a billing search listing obtained in step 715 is greater than the output number stored in step 712. As a result of the determination, if the number of the billing search listing is greater than the output number of page 1, a billing search listing that exceeds the output number of page 1 is output following the second page in the prior art. However, in case where the billing search listing is output following the second page, there is a significant difference in view of an advertising effect compared to a search listing output at the bottom of page 1. This is because the searcher does not go to page 2 if the searcher obtains satisfactory results at page 1. Therefore, in the present invention, if the number of the billing search listing is greater than the output number, all the billing search listings are output at page 1 of the search result output screen (step 717). According to the present invention, it is guaranteed that a search listing of a network information provider who purchased a search word is displayed on page 1 of a search result screen for a corresponding search word.

As a result of the determination in step 716, if the number of billing search listings is smaller than the output number, the billing search listing is first displayed and a search listing (according to an embodiment of the present invention, a search listing whose bid amount is “0”) that is not charged is displayed at the bottom.

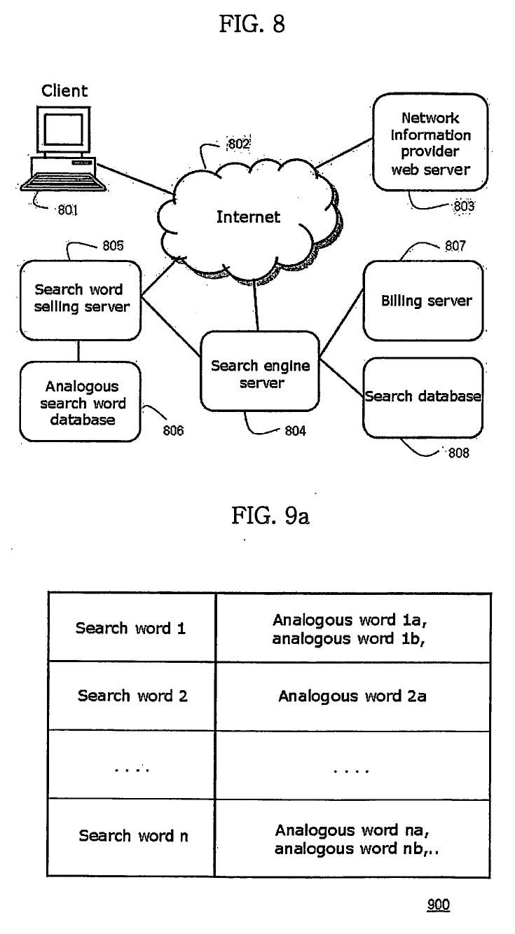

FIG. 8 shows the configuration of a network for providing services that sell a search word to a network information provider according to an embodiment of the present invention.

A search word selling server 805 sells search words of a search engine server to network information providers. In other words, if a searcher accesses a search engine server 804 and then requests a search by inputting a search word, the search engine provides the searcher with a search result for the search word. At this time, the network information providers purchase the search words so that information on their web sites can be placed at an upper side of a search result displayed. Such a purchase of the search words is performed in the search word selling server 805. An analogous search word database 806 is a database for storing analogous search words for respective search words therein. Since a search engine server 804, a billing server 807 and a search database 808 are the same as the components shown in FIG. 4, reference can be made to the description regarding FIG. 4.

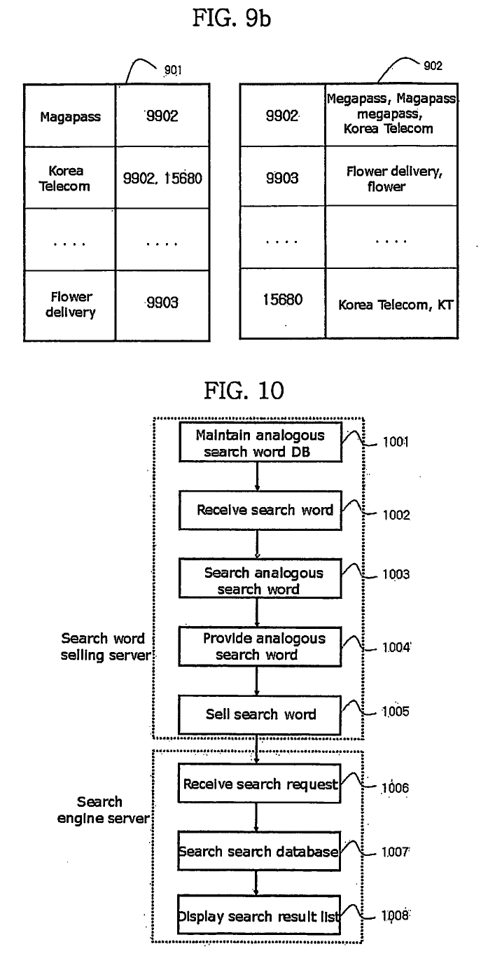

FIG. 9a shows the configuration of an analogous search word database, for selling search words to network information providers according to an embodiment of the present invention. Analogous search word databases 806 and 900 store analogous search words for respective search words therein. Though the analogous search word database having a table format is shown in FIG. 9a, it may have various types such as a linked list.

FIG. 9b shows the configuration of an analogous search word database according to another embodiment of the present invention. In this embodiment, the analogous search word database includes an identifier database 901 and an analogy word database 902. The analogy word database 902 stores analogous words for a single identifier therein. The identifier may be a category identifier representing a search category or a site identifier representing a search word. In this embodiment, a search word or a category called “Magapass” is allocated with an identifier 9902. A search word or a category called “Korea Telecom” is allocated with identifiers 9902 and 15680. According to another embodiment of the present invention, a single identifier may be allocated to each search word or each category. In a case where a plurality of identifiers are allocated to a single search word, groups of analogy words for the single search word are formed, so that words belonging to one group of analogy words are prevented from increasing beyond a certain size. The analogy word database 902 stores “Megapass”, “Magapass”, “megapas” and “Korea Telecom” therein as analogy words corresponding to the identifier 9902.

The analogy word may be extracted by using users' search statistic by means of a search service provider. For example, there are many cases where users erroneously input a search word “Magapass” instead of “Megapass”. This can be extracted through the frequency of search words input by searchers. Also, an analogy word can be extracted by removing only specific portions from URL. For example, if URL for a Megapass service is provided at “http://www.megapass.co.kr”, an analogy word for “Megapass” can be extracted by removing “http://www” at the front end of the URL, “co.kr” at the rear end of the URL and extracting only “Megapass”. It is further possible to extract an analogy word for a specific keyword by using an electronic synonym dictionary. According to another embodiment of the present invention, it is possible for a search service provider to add an analogy word for a specific keyword. A search service provider inputs “Korea Telecom” as an analogy word of “Megapass” based on the fact that users who want to become a member to “Korea Telecom Megapass” frequently input “Korea Telecom” as a search word. Eventually, the analogy word database informs a sponsor of the fact that there is a difference between search words intended by users and search words actually input by the users in an Internet search service as information. Thus, the sponsor can select a search word more suitable for advertisement of its own web page. Therefore, the sponsor who tried to purchase only a search word “Megapass” additionally buys search words “Magapass” and “megapass”. As a result, the Internet search service provider can make a high profit and the sponsor can advertise more efficiently.

FIG. 10 is a flowchart illustrating sequences of embodying a method for selling a search word to a network information provider according to an embodiment of the present invention. Steps 1001 to 1005 in FIG. 10 are operations performed in the search word selling server 805 and steps 1006 to 1008 are operations performed in the search engine server 804.

In step 1001, the search word selling server 805 maintains the analogous search word database 806. The analogous search word database 806 stores analogous search words for search words therein. In step 1002, the search word selling server 805 receives a search word that is to be purchased by a network information provider. For example, a network information provider, who wants his or her web page to be located at the top of a search result for a search word “digital camera”, will try to purchase the search word by inputting the search word “digital carnera” to the search word selling server 805.

In step 1003, the search word selling server 805 searches the analogous search word database 806 for an analogous search word corresponding to the received search word. In step 1004, the search word selling server 805 provides the identified analogous search word to the network information provider. For example, a network information provider, who tries to purchase a search word “digital camera”, may be interested in search words “digital camcorder”, “camera” and the like. Thus, these analogous search words are provided to the network information provider. In step 1005, the network information provider buys a necessary search word considering all the analogous search words presented by the search word selling server 804.

In step 1006, the search engine server 804 receives a search request from the client 801. The search engine server 804 searches the search database 808 based on the received search word (step 1007) and provides a search result to the client as a search result list (step 1008). The search result is provided in order of a search listing of a network information provider having a higher bid amount for a corresponding search word. If the search clicks a search listing included in the provided search result list, the billing server 807 charges a corresponding network information provider.

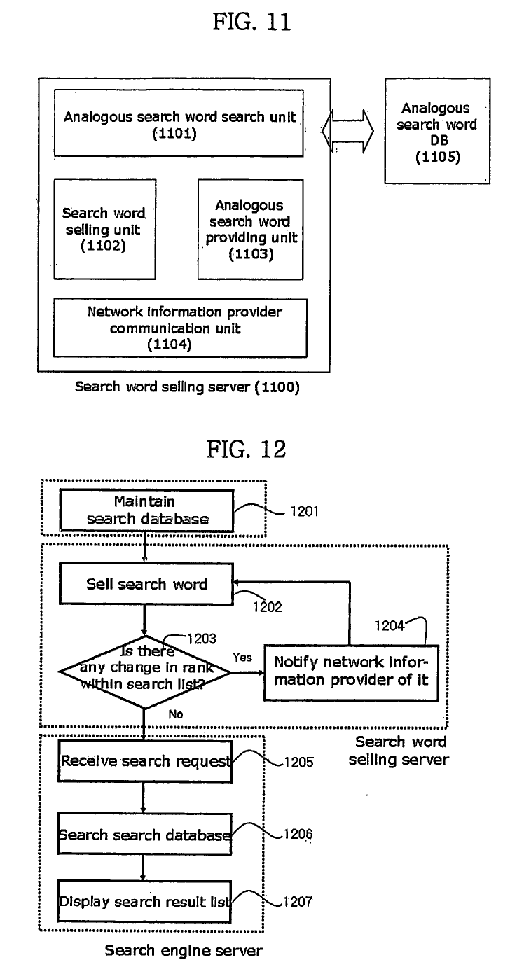

FIG. 11 is a block diagram illustrating a search word selling server and an analogous search word database for selling a search word to a network information provider according to an embodiment of the present invention.

A search word selling server 1100 includes an analogous search word search unit 1101, a search word selling unit 1102, an analogous search word providing unit 1103 and a network information provider communication unit 1104. The network information provider communication unit 1104 receives a search word purchase request from a network information provider and transfers a received search word to the analogous search word search unit 1101. The analogous search word search unit 1101 searches the analogous search word database 1105 for an analogous search word analogous to the received search word. The identified analogous search word is provided to the network information provider through the analogous search word providing unit 1103. The network information provider determines a search word suitable for a client based on the received analogous search word information to buy a search word. The search word selling unit 1102 serves to sell a search word. The selling of the search word is performed by writing a title, URL, description, a search word and a bid amount for a network information provider's web page into the search database 808 and recording account information of the network information provider for a charge.

FIG. 12 is a flowchart illustrating sequences of embodying a method for notifying a network information provider of the fact that the rank of a search listing displayed within a search result list is changed according to an embodiment of the present invention.

This embodiment is for satisfying the needs of a network information provider who wants his or her search listing to be displayed as a predetermined rank within a search result list. In a prior art, if a second network information provider proposes a higher bid amount after a first network information provider purchased a search word, a search listing of the first network information provider is displayed below a search listing of the second network information provider.

Therefore, in this embodiment, a search word is sold (step 1202). It is then determined whether there is a network information provider of a search listing whose rank has changed within the search list (step 1203). In step 1204, this fact is notified to the network information provider. According to another embodiment of the present invention, the network information provider can determine his or her rank within a desired search result list when purchasing a search word, and can set a search word selling server so that it informs him or her of the fact that the network information provider's search listing rank has changed

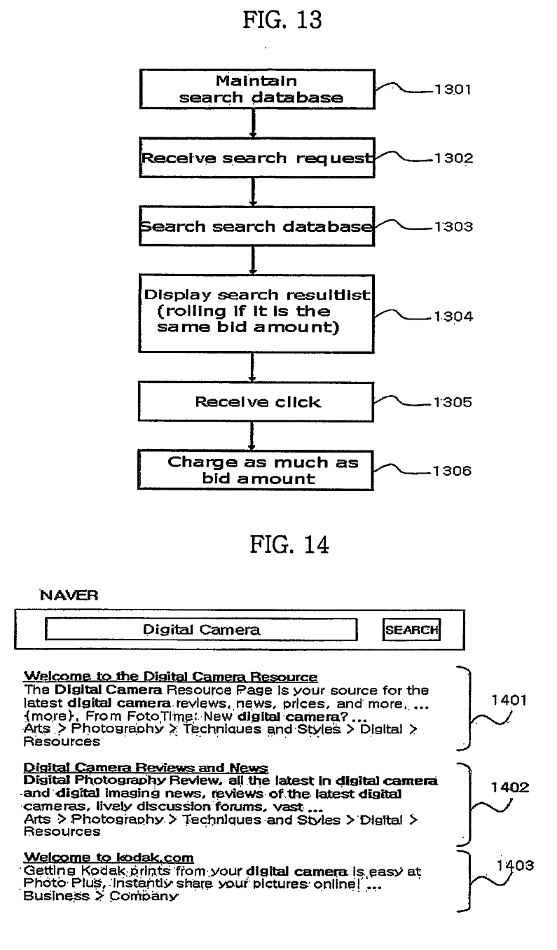

FIG. 13 is a flowchart illustrating sequences of embodying a method for generating a search result list according to an embodiment of the present invention.

If a plurality of network information providers buy a single search word at the same bid amount, there is a problem in displaying a search listing corresponding to the plurality of the network information providers. This embodiment is for solving such a problem.

Steps 1301 to 1303 in FIG. 13 are the same as steps 301 to 303 in FIG. 3. Reference can be made to description related to FIG. 3. In step 1303, a search listing for a search word received from a searcher is identified by searching a search database. The identified search listings are arranged in a search list according to each bid amount associated with the identified search listing (step 1304). At this time, if the number of the search listings identified for the search word is plural and bid amounts included in the search listing are same, the plurality of the search listings are rolled and arranged.

FIG. 14 shows a search result list generated according to the embodiment of FIG. 13.

If a search listing 1402 and a search listing 1403 have the same bid amount, the search listing 1402 and the search listing 1403 are rolled and displayed when displaying a search result listing for the search word “Digital Camera”. According to a preferred embodiment of the present invention, a search listing is rolled and displayed by displaying a location in turn every time when a search word is input.

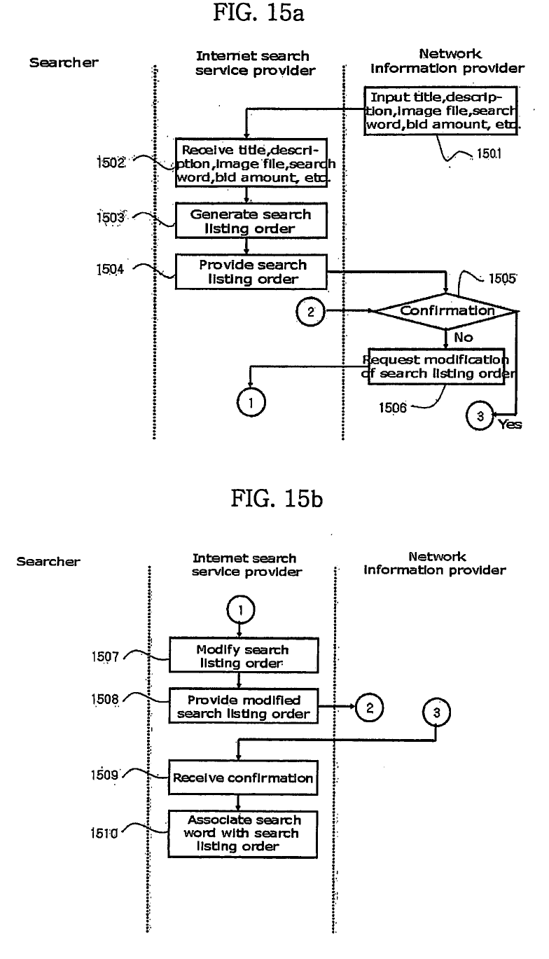

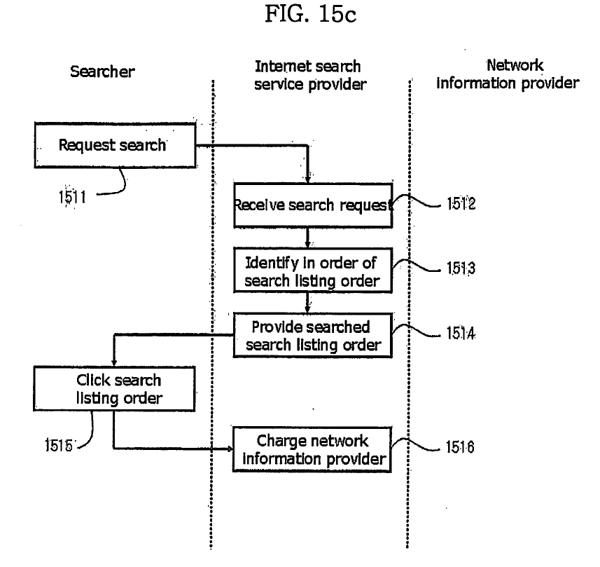

FIGS. 15a, 15b, and 15c are flowcharts illustrating sequences of receiving a search listing including an image file and a bid amount from a network information provider, and displaying a search listing associated with a network information provider who is successfully bidden at a predetermined region when displaying the search listing according to an embodiment of the present invention.

In step 1501, a network information provider accesses an Internet search engine server of an Internet search service provider to input a search word for which the provider will make a bid and information necessary to generate a search listing. According to an embodiment of the present invention, the search listing is displayed to a searcher with it including an image file. According to this embodiment, this method has an advantage that it can attract the interest of a searcher to the search listing. Information input by a network information provider may include a search word to make a bid, a title of a web site and description on the web site, an image file associated with the web site, URL of the web site and a bid amount. According to another embodiment of the present invention, the information input by the network information provider may include additional description on the web site, a contact point such as a telephone number and an address of the network information provider.

In step 1502, an Internet search engine receives information related to the search listing, which is input by the network information provider in step 1501. In step 1503, the Internet search engine generates a search listing substantially in real time based on the title of the web site, description on the web site, the image file, URL and the additional description, which are received from the network information provider. The generated search listing is stored in a temporary search listing storage unit substantially in real time. The search listing generated in step 1503 is provided to a network information provider substantially in real time (step 1504). An example of a search listing provided to a network information provider is shown in FIG. 13, which will be described later.

In step 1505, the network information provider determines whether the search listing provided in step 1504 needs to be modified. If it is determined that the search listing needs not to be modified, “confirmation” is selected. If the search listing needs to be modified, “modification” is selected. If “modification” is selected in step 1505, a request of the network information provider to modify the search listing is input to the Internet search engine through a communication network (step 1506). In step 1507, the Internet search engine reflects the request for modification of the network information provider to modify the search listing substantially in real time. The modified search listing is provided to the network information provider substantially in real time in step 1508. The network information provider selects “confirmation” or “modification” (step 1505).

If the network information provider selects “confirmation” in step 1505, the selection of “confirmation” is transferred to the Internet search engine (step 1509). In step 1510, a search listing and a search word are associated. The association of the search listing and the search word is for identifying the search listing when a searcher performs a search using a search word. This step may be performed after or before other steps that do not have any problems in performing step 1510 as well as immediately after step 1509.

In step 1511, the searcher accesses an Internet search engine to input a search word to a search window, thus requesting a search to the Internet search engine. The Internet search engine receives the search request (step 1512) and searches a search listing associated with a search word corresponding to the search request (step 1513). In step 1514, the identified search listing is positioned at a predetermined location of a web page to provide the search result to the searcher.

If the searcher clicks the search listing (step 1515), the Internet search service provider claims demand to the network information provider using a billing server (step 1516).

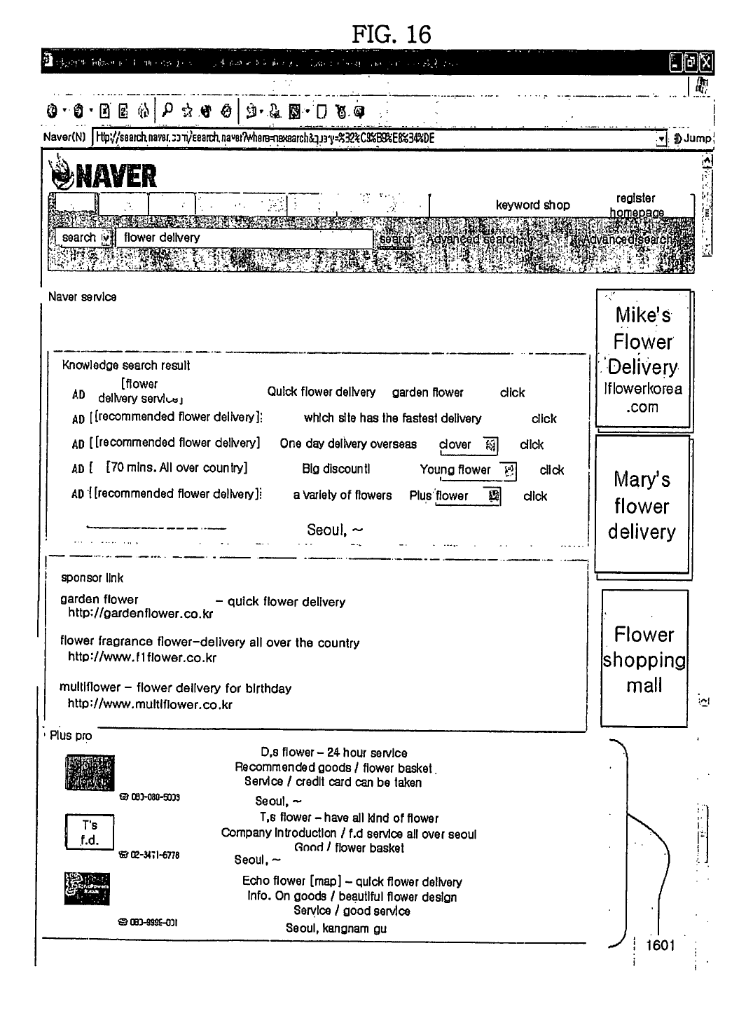

FIG. 16 shows a search result screen displayed according to the embodiments illustrated in FIGS. 15a, 15b, and 15c.

FIG. 16 shows an embodiment of a search result web page provided to the searcher in step 1514. The searcher has input the search word “flower delivery”. A search listing corresponding to the search word is displayed by reference numeral 1601. The search listing 1601 includes an image file. The inclusion of the image file in the search listing can attract the interest of a searcher. As a result, there is a high possibility that a searcher may click the search listing 1601.

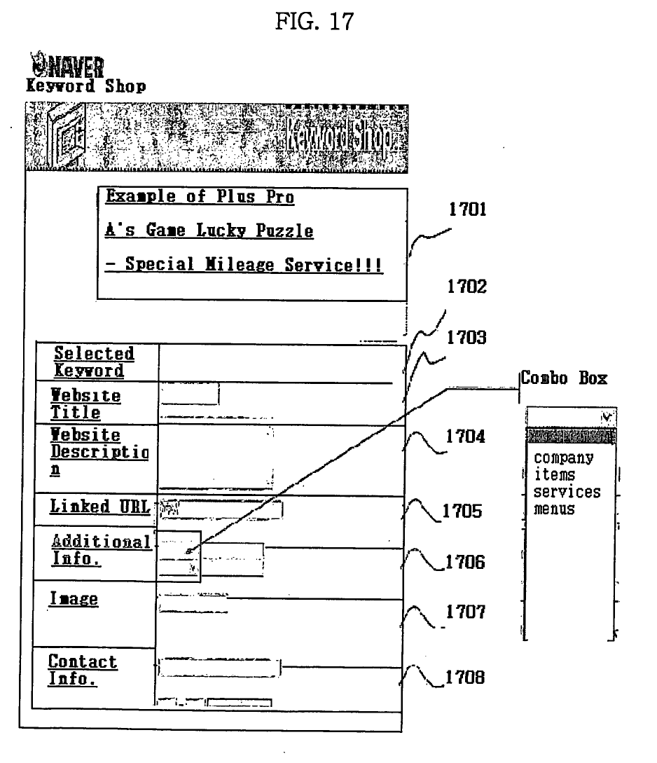

FIG. 17 shows a screen for receiving information on a search listing from a network information provider.

A search listing example 1701 shows what type will be a search listing displayed when the search listing is displayed as a result of a search. Thus, a network information provider can know how a search listing for which the provider will make a bid will be displayed as a result of the search.

A selected keyword field 1702 indicates a search word for which a network information provider will make a bid. In this embodiment, if the network information provider selects a search word to make a bid, a web page of FIG. 17 is displayed. According to this embodiment, the network information provider can first determine the suitability of a search word and then inputs additional search listing information, in order to remove unnecessary search listing information input.

A website title field 1703 is a field for inputting the title of a web page provided by a network information provider. A website description field 1704 is a field for inputting a description of a web page provided by the network information provider. A linked URL field 1705 is a field for inputting a URL for a destination web site when a searcher clicks a search listing. An additional information field 1706 is a field for inputting additional information to the network information provider. An image field 1707 is a field for inputting the location of an image file to be uploaded to an Internet search engine. The image file is transmitted from a device of the network information provider to an Internet search engine server when the network information provider inputs “confirmation”. A contact point information field 1708 is used to receive contact point information such as a telephone number and an address associated with a network information provider. Further, a search listing input screen includes a bid amount input field for receiving a bid amount for a search listing from a network information provider (a bid amount input field is not shown).

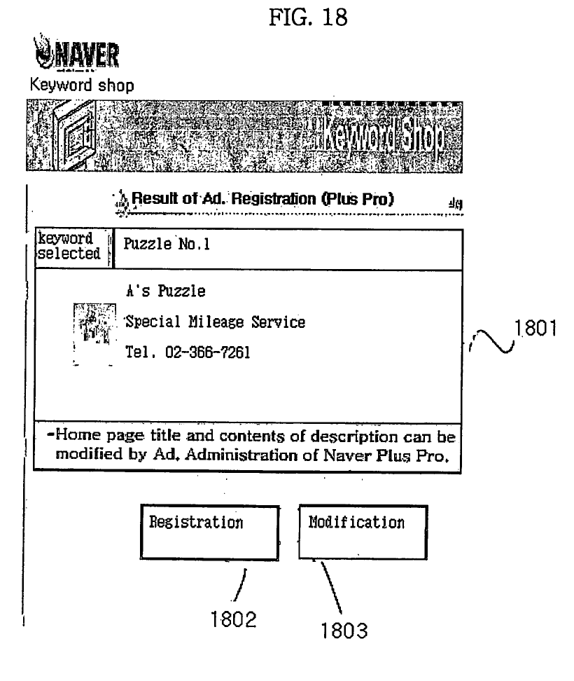

FIG. 18 shows a screen for displaying a search listing that will be provided to a searcher to a network information provider substantially in real time on the basis of search listing information input by the network information provider. An Internet search engine generates a search listing that will be provided as a result of a search by using a title, description and an image file of a web page, which are input by the network information provider, and then provides the generated search listing to the network information provider, as shown in FIG. 18.

The network information provider reviews a generated search listing 1801. As a result of the review, if the generated search listing needs to be modified, the provider clicks a modification button 1803 to transmit a modification request to a network search engine. The network search engine that received the modification request provides a search listing modification screen web page to the network information provider so that the network information provider can modify the contents of the search listing.

If it is determined that the generated search listing needs not to be modified after the network information provider reviews the generated search listing 1801, the network information provider clicks a registration button 1802 to transmit to the network search engine information on that the network information provider has “confirmed”. If receiving the “confirmation” information, the network search engine has the search listing information stored in the search listing database.

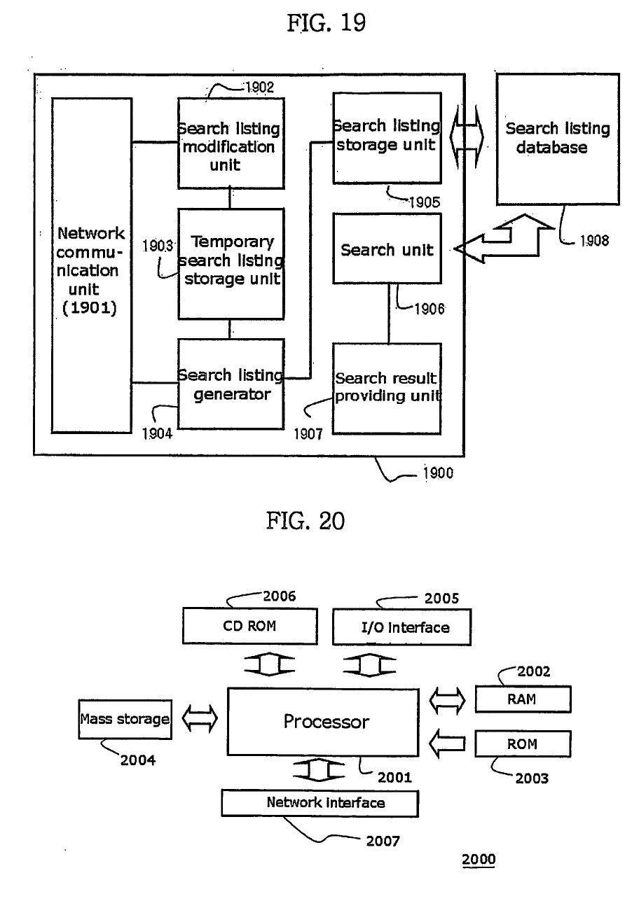

FIG. 19 shows a search result list generating system for generating and storing a search listing substantially in real time based on information provided by a network information provider according to an embodiment of the present invention.

An Internet search engine 1900 includes a network communication unit 1901, a search listing modification unit 1902, a temporary search listing storage unit 1903, a search listing generator 1904, a search listing storage unit 1905, a search unit 1906 and a search result providing unit 1907.

The network communication unit 1901 receives a search request from a searcher through a communication network and transmits a search result to a device of the searcher through the communication network. Further, the network communication unit 1901 receives information on a search listing (including an image file) from a network information provider through the communication network and transmits a generated search listing to a device of the network information provider through the communication network.

Based on the search listing information received from the network information provider through the network communication unit 1901, the search listing generator 1904 generates a search listing and stores the generated search listing in the temporary search listing storage unit 1903. The search listing stored in the temporary search listing storage unit 1903 is provided to the device of the network information provider through a search listing providing unit (not shown) and the network communication unit 1901. The search listing providing unit serves to transfer the search listing, which is generated or modified through the search listing generator 1904 and the search listing modification unit 1902 and is then stored in the temporary search listing storage unit 1903, to the network communication unit 1901.

If the network information provider requests that a search listing be modified, the modification request is sent to the network communication unit 1901 and is then transferred to the search listing modification unit 1902. The search listing modification unit 1902 modifies the search listing stored in the temporary search listing storage unit 1903 and then provides the modified search listing to the network information provider again.

If a “confirmation” input is received from the network information provider, the search listing storage unit 1905 has the search listing stored in the temporary search listing storage unit 1903 stored in a search listing database 1908. A successful bid decision unit (not shown) selects a successful bidder from a search listing, which is associated with the same search word and stored in the search listing database 1908, according to a bid amount.

The search request input by a searcher through the network communication unit 1901 is transferred to the search unit 1906. The search unit 1906 searches the search listing database 1908 for a search listing associated with the same search word. The identified search listing is arranged in a search result web page in order of a bid amount associated with a search listing by means of the search result providing unit 1907, and is then provided to the searcher.

In the present invention, communication among respective devices, the Internet search engine and the server may be performed using HTTP protocol and other Internet protocols.

In the present invention, other components such as a search engine server, a billing server, a search database and an analogous search word database have been described as separate components. However, those components may be constructed physically in a single system.

Although the present invention has been described in connection with the embodiment of the present invention illustrated in the accompanying drawings, it is not limited thereto since it will be apparent to those skilled in the art that various substitutions, modifications and changes may be made thereto without departing from the scope and spirit of the invention.

In addition, embodiments of the present invention further relate to computer readable media that include program instructions for performing various computer-implemented operations. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

FIG. 20 is an internal block diagram illustrating the configuration of a general-purpose computer system, which can be adopted to construct a search engine server, a billing server, a network information provider web server and a search word selling server according to the present invention.

The computer system 2000 includes any number of processors 2001 (also referred to as central processing units, or CPUs) that are coupled to storage devices including primary storage 2002 (typically a random access memory, or “RAM”), primary storage 2003 (typically a read only memory, or “ROM”). As is well known in the art, primary storage acts to transfer data and instructions uni-directionally to the CPU and primary storage is used typically to transfer data and instructions in a bi-directional manner. Both of these primary storage devices may include any suitable type of the computer-readable media described above. A mass storage device 2004 is also coupled bi-directionally to CPU 2001 and provides additional data storage capacity and may include any of the computer-readable media described above. The mass storage device 2004 may be used to store programs, data and the like and is typically a secondary storage medium such as a hard disk that is slower than primary storage. A specific mass storage device such as a CD-ROM 2006 may also pass data uni-directionally to the CPU. Processor 2001 is also coupled to an interface 2005 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, processor 2001 optionally may be coupled to a computer or telecommunications network using a network connection as shown generally at 2007. With such a network connection, it is contemplated that the CPU might receive information from the network, or might output information to the network in the course of performing the above-described method steps. The above-described devices and materials will be familiar to those of skill in the computer hardware and software arts.

The hardware elements described above may be configured (usually temporarily) to act as one or more software modules for performing the operations of this invention.

### INDUSTRIAL APPLICABILITY

According to the present invention, there is provided an Internet search service method and apparatus for providing a variety of billing means to a network information provider by properly reflecting a profit made by the network information provider. Furthermore, according to the present invention, there is provided an Internet search service method and apparatus for not claiming payment to a search listing displayed following the second page.

According to the present invention, there is provided an Internet search service method and apparatus wherein a network information provider who wants to purchase a search word is provided with a search word analogous to the search word, so that the network information provider selects a more proper search word or a plurality of search words to increase advertising effects. In addition, according to the present invention, there is provided a method and apparatus for equally displaying a search result list to a plurality of network information providers who propose the same bid amount for the same search word.

According to the present invention, an image is included in a search listing so that it is very attractive to a searcher and a network information provider can easily input and modify information of a search listing.

It should be noted that the forgoing embodiments are merely illustrative and are not to be construed as limiting the present invention. The scope of the present invention is defined by the appended claimed rather than the detailed description of the present invention. All changes or modifications or their equivalents made within the meanings and scope of the claims should be construed as falling within the scope of the present invention.

1. A method for generating a search result list using a computer network in response to a search request from a searcher, comprising the steps of:
maintaining a database for storing a plurality of search listings therein, each of the search listings including a network position and a search word associated with a network information provider;
receiving the search request from the searcher;
searching a search listing having a search word corresponding to the search request;
providing the searched search listing to the searcher as a search result list;
if the searcher clicks a search listing of the search result list to access a web page of a network information provider associated with the clicked search listing, receiving predetermined information on the use of the web page by the searcher; and
charging the network information provider based on the received predetermined information on the use of the web page by the searcher.

2. The method as claimed in claim 1, wherein the predetermined information is information on whether the searcher has become a member to services provided by the network information provider.

3. The method as claimed in claim 1, wherein the predetermined information is information on whether the searcher has used a charged service provided by the network information provider.

4. The method as claimed in claim 1, wherein the predetermined information is information on the use fee that the searcher uses for a charged service provided by the network information provider.

5. The method as claimed in claim 1, wherein the network information provider provides electronic commerce, and the predetermined information is information on a product purchase amount that are made by the searcher through the electronic commerce provided by the network information provider.

6. A method for generating a search result list using a computer network in response to a search request from a searcher, comprising the steps of:
maintaining a database for storing a plurality of search listings therein, each of the search listings including a network position and a search word associated with a network information provider;
receiving the search request from the searcher;
searching a search listing having a search word corresponding to the search request;
arranging the searched search listing as a search result list; and
if the searcher clicks a search listing of a search result list displayed at a first page of the search result list arranged as the search result list, performing a predetermined charge to the network information provider, and if the searcher clicks a search listing of a search result list displayed at other pages except for the first page, not performing the charge to the network information provider.

7. A method for generating a search result list using a computer network in response to a search request from a searcher, comprising the steps of:
maintaining a database for storing a plurality of search listings therein, each of search listings including a network position and a search word associated with a network information provider;
maintaining an output number of a search listing provided at a first page as a search result list, in response to the search request of the searcher;
receiving the search request from the searcher;
searching a search listing having a search word corresponding to the search request;
determining the number of a billing search listing charged to the network information provider associated with the searched search listing; and
if the number of the billing search listing is greater than the output number, arranging and providing all the billing search listing at a first page of a search result display page.

8. A method for generating a search result list using a computer network in response to a search request from a searcher, comprising the steps of:
maintaining a database for storing one or more analogous search words associated with a search word therein;
receiving a search word associated with a predetermined search result listing display method at an Internet search engine from a network information provider;
searching the database for an analogous search word associated with the search word;
providing the network information provider with the searched analogous search word;
receiving an input regarding a purchase of the search word or the analogous search word from the network information provider;
receiving a search request from the searcher;
searching a search listing having a search word corresponding to the search request; and
providing the searched search listing to the searcher according to the predetermined search result listing display method.

9. A method for generating a search result list using a computer network in response to a search request from a searcher, comprising the steps of:
maintaining a database for storing a plurality of search listings therein, each of the search listing including a network position and a search word associated with a network information provider;
receiving a bid amount for a search listing associated with a first network information provider from the first network information provider;
receiving the search request from the searcher;
searching a search listing having a search word corresponding to the search request;
arranging the searched search listing as a search list according to each bid amount associated with the searched search listing;
receiving a bid amount for a search listing associated with a second network information provider from the second network information provider; and
providing the first network information provider with information on that the order within the search list of the search listing associated with the first network information provider is changed according to the bid amount inputted by the second network information provider.

10. A method for generating a search result list using a computer network in response to a search request from a searcher, comprising the steps of:
maintaining a database for storing a plurality of search listings therein, each of the search listings including a network position and a search word associated with a network information provider;
receiving a first bid amount for a search listing associated with a first network information provider from the first network information provider;
receiving a second bid amount for a search listing associated with a second network information provider from the second network information provider;
receiving the search request from the searcher;
searching a search listing having a search word corresponding to the search request; and
arranging the searched search listing as a search list according to each bid amount associated with the searched search listing, wherein if the first bid amount and the second bid amount are identical, the search listing associated with the first network information provider and the search listing associated with the second network information provider are rolled and arranged.

11. A method for generating a search result list in response to a search request input through a communication network from a searcher, comprising the steps of:
receiving a web page title, a web page description, an image file, a search word and a bid amount associated with a web page of a network information provider from the network information provider;
generating a search listing substantially in real time in combination with the web page title, the web page description and the image file and providing the generated search listing to the network information provider;
receiving a confirmation input of the network information provider for the generated search listing;
associating the search word with the search listing;
receiving the search request from the searcher;
searching a search listing associated with a search word corresponding to the search request;
arranging the searched search listing in order of a bid amount associated with the searched search listing and then generating a search result list; and
providing the generated search result list to the searcher.

12. The method as claimed in claim 11, further comprising the steps of:
receiving a modification request for one or more of the web page titles, web page descriptions and image files from the network information provider; and
modifying the search listing substantially in real time in response to the modification request, and providing the modified search listing to the network information provider.

13. A computer-readable recording medium in which a program for implementing a method according to claim 1 is recorded.
